(19) United States
(12) Patent Application Publication
(10) Pub. No.: US 2019/0350180 A1
(43) Pub. Date: Nov. 21, 2019

(54) Tamper Evident Lobster Trap

(71) Applicants: Scott Moser, San Diego, CA (US); Dermot O'Shea, San Diego, CA (US)

(72) Inventors: Scott Moser, San Diego, CA (US); Dermot O'Shea, San Diego, CA (US)

(21) Appl. No.: 15/985,297

(22) Filed: May 21, 2018

(51) Int. Cl. A01K 69/08

(52) U.S. Cl. CPC A01K 69/08; G06K 19/07749

(57) ABSTRACT

Disclosed generally is a tamper evident lobster trap. In use, the invention may operate to detect and alert a user to theft of lobsters and tampering of the harvesting process.

### CROSS-REFERENCE TO RELATED APPLICATIONS

Not applicable.

### STATEMENT REGARDING FEDERALLY SPONSORED RESEARCH OR DEVELOPMENT

Not applicable.

### THE NAMES OF THE PARTIES TO A JOINT RESEARCH AGREEMENT

Not applicable.

### REFERENCE TO AN APPENDIX SUBMITTED ON A COMPACT DISC AND INCORPORATED BY REFERENCE OF THE MATERIAL ON THE COMPACT DISC

Not applicable.

### STATEMENT REGARDING PRIOR DISCLOSURES BY THE INVENTOR OR A JOINT INVENTOR

Reserved for a later date, if necessary.

### BACKGROUND OF THE INVENTION

### Field of Invention

The disclosed subject matter is generally in the field of crustacean trapping and harvesting. Specifically, the disclosed subject matter is in the field of lobster trapping and fishing.

### Background of the Invention

Lobster theft and trap tampering is an ongoing and serious concern in the fishing and trapping industry. Trap “molestation” and theft of lobsters puts a serious financial burden on the livelihoods of those employed in the fishing industry. Losing even a small percentage of the total annual harvest translates to huge numbers in wholesale value lost in addition to the loss incurred through boating runs to surface empty lobster traps. Fisherman generally check and rebait their traps every three or four days, with each run to the traps costing hundreds of dollars in fuel and an excess of twelve hours worth of labor.

Lobster traps are generally strung together and connected to buoys, which makes them easily locatable by poachers. Typically, a few days span in between lobster runs, which can leave plenty of time for thieves to visit and empty sitting lobster traps. Such poaching is deemed a serious enough offense to warrant the development of regulatory agencies charged with gathering information that leads to the arrest or summons for fishing and wildlife violations such as the Maine Operation Game Thief, an organization that works with the Department of Inland Fisheries & Wildlife, Maine Warden Service, Department of Marine Resources, and Maine Marine Patrol. Even state laws protect the licensed owner's interest in lobsters caught within their traps (See Connecticut Code Sec. 26-167).

Thus, a need exits for a lobster trap that alerts an owner to unauthorized tampering and potential theft of the trap.

### SUMMARY OF THE INVENTION

In view of the foregoing, an object of this specification is to disclose a tamper evident lobster trap. Another object of this specification is to disclose a device and related methodology that combats theft of trapped lobsters and disruption of the harvesting process.

In a typical embodiment, the lobster trap features an attached sensor and database. The sensor comprises an electronic sensor and process powered by a battery and enclosed in a housing receptacle. In one embodiment, the sensor detects pressure changes and is activated via these changes. Suitably, the pressure-detecting sensor remains dormant while below a certain depth of water and then activates once above water to record the altered status of the trap to the database. For instance, the date, time, weight of the cage, etc. is recorded to the sensor's database whenever the trap is raised above the water surface allowing for the inference of tampering from data recorded on the sensor. In one embodiment, the sensor communicates to a simple cellular based unit that alerts when there is a change in fluid level. In another embodiment, the sensor detects changes in temperature, either singularly or in addition to changes in pressure.

In a further embodiment, a weight detector is attached to the lobster trap along with the sensor. Suitably, the weight detector monitors changes of weight of the lobster trap. In another embodiment, the data may be communicated via near-field communication techniques to either a boat, cell phone, or the like. In yet another embodiment, attachment loops may be connected to the pressure-detecting sensor to facilitate extraction of the lobster trap from water.

In still another embodiment, the sensor communicates with a PC or base unit that utilizes an application to store and process the trap information as well as send and receive such information from a remote server via cellular or satellite communications. A computer system utilizes an ISM (international, scientific and medical) Band Radio, RF (coaxial) cable, and antenna to wake up the trap units and capture the data and record it into the application.

In another embodiment, the sensor may be activated and information may be relayed to a handheld unit or PC containing compatible radio technology. Information such as owner identification, time, location, and weight data would be available to agents conducting government audits. Government audits routinely count lobster traps in and out of the water, and the ability for the government to communicate with the sensor on the lobster traps would facilitate the process by allowing government units to “wake up” the trap sensors and gather relevant information. Further, the communication would be done in an encrypted fashion once the traps are woken up by government units.

In still a further embodiment, the lobster trap exhibits a dual-triggered mechanical switch that monitors the coming and going of lobsters from the trap. The mechanical switch may be triggered by an attached transparent acrylic arm that is mounted to the switch in such a way that when a lobster enters or exits the trap, the arm is toggled and activates the switch. In a typical embodiment the mechanical switch rests in a neutral position. Entrance of a lobster toggles the distal end of the arm which, in turn, pushes the switch into a temporary loaded position followed by a return to its neutral position induced by the spring-loaded nature of the switch. Exit of a lobster likewise toggles the arm, which in turn pushes the switch into a temporary back-loaded position followed by a return to its neutral position induced by the spring-loaded nature of the switch. Such movements into the temporary loaded positions trigger the recording of time stamping and accounting of the total entries and exits via a wired connection to a monitoring device.

### DESCRIPTION OF RELATED ART

FR2795703 by Vicente (circa 1999) discloses a “Submerged anti-theft device, for preventing theft or accidental loss of nets or lobster pots, has programmable unit which unlocks tow reel only when programmed date and time is reached” The document is written in French, but the translated title suggests that it is a reel for lobster traps that can only be operated at certain preset times.

U.S. Pat. No. 3,622,962 by the U.S. Navy (circa 1971) discloses a “free fall oceanographic beacon.” The buoy has a pressure sensor to determine when the anchor is on the sea floor.

U.S. Pat. No. 4,262,379 by Jankiewicz (circa 1981) discloses a lobster trap that has a location buoy that only floats to the surface after a preset timeframe or at a preset time and date. The trap can be hidden from thieves until the time and date for collection of trapped lobster.

U.S. Pat. No. 4,373,288 by McCrink (circa 1983) discloses a “signaling means for a crustacean trap.” This trap has a buoy that is released when a crustacean is trapped.

U.S. Pat. No. 4,393,617 by Charnoske (circa 1983) discloses an “animal trap signal.” This is just a bobber that raises to the surface when a lobster is trapped.

U.S. Pat. No. 4,434,575 by Pearson (circa 1984) discloses a “marine trap sensing system.” This trap sets of an alarm whenever the trap is triggered.

U.S. Pat. No. 4,486,973 by Faucillon (circa 1984) discloses a “shellfish trap.”

U.S. Pat. No. 4,864,770 by Serio (circa 1989) discloses a “collapsible crustacean trap.”

U.S. Pat. No. 5,421,177 by Sieber et al. (circa 1995) discloses a “security tag which can be fitted to an object, for signaling an attempted theft.” This is just a tamper evident padlock.

U.S. Pat. No. 5,477,635 by Orsano (circa 1995) discloses a “signaling apparatus for use with a disposable animal trap.” This trap sends a signal whenever a trigger is tripped.

U.S. Pat. No. 5,555,666 by Glatzer (circa 1996) discloses “crab fishing by remote monitoring.” This trap alerts the user to a vulnerable crab.

U.S. Pat. No. 5,887,176 by Randtec, Inc. (circa 1999) discloses a “method and system for remote monitoring and tracking of inventory.”

U.S. Pat. No. 6,069,563 by Kadner et al. (circa 2000) discloses a “seal system.” This system records tampering events and reports such events to a computer whenever the lock is interrogated.

U.S. Pat. No. 6,775,946 by Wright (circa 2004) discloses a “remote identifying animal trap.” This technology reports the status of several scattered traps.

U.S. Pat. No. 7,026,942 by Cristofori et al. (circa 2006) discloses a “method for signaling the presence of prey in traps for vermin and device or carrying out this method.”

U.S. Pat. No. 7,135,976 by Neff et al. (circa 2006) discloses a “wireless monitoring device.” This method monitors the change in status or condition of a container using monitoring units mounted to the container.

U.S. Pat. No. 7,239,238 by Tester et al. (circa 2007) discloses an “electronic security seal.”

U.S. Pat. No. 8,553,501 by Cota (circa 2013) discloses a “tracking system for underwater equipment.” This system is for monitoring the position of lobster traps. In some embodiments, there are cameras, temperature sensors, and chemical analyzers for recording the environmental conditions of the trap.

U.S. Pat. No. 9,091,550 by Smith (circa 2015) discloses a “GPS shellfish trap setting system.”

U.S. Pat. No. 9,210,917 by Head (circa 2015) discloses a “ bait fish trap.” The trap has a capacity indicator.

US20090015400 by Breed (circa 2009) discloses “shipping container monitoring based on door status.” A status indicator conveys information about whether the door is open or closed. This can be used for theft prevention or acknowledgment.

US20090201152 by Karr et al. (circa 2009) discloses an “anti-tamper cargo container locator system.”

US20100265068 by Brackmann et al. (circa 2010) discloses a “system for maintaining security of evidence throughout chain of custody.”

US20130033381 by Breed discloses “Cargo theft prevention using text messaging.”

US20140157649 by Havents et al. (circa 2014) discloses a degradable identification component that displays anti-theft information.

US20140305026 by Pemberton (circa 2014) discloses “devices, systems, methods, and kits for attracting crabs or lobsters in an aquatic environment.”

US20160081315 by Knott, Jr. (circa 2016) discloses a “creel and method of making a creel for trapping crustaceans.”

### BRIEF DESCRIPTION OF THE SEVERAL VIEWS OF THE DRAWINGS

Other objectives of the disclosure will become apparent to those skilled in the art once the invention has been shown and described. The manner in which these objectives and other desirable characteristics can be obtained is explained in the following description and attached figures in which:

FIG. 1. is an exploded view of the lobster trap sensor and processor; and,

FIG. 2. Is an environmental view of the lobster trap with the sensor and process attached;

FIG. 2A is a zoom-in view of the trap of FIG. 2;

FIG. 3 is an exploded view of the lobster trap sensor and processor with attachment loops connected;

FIG. 3A is a schematic of a tamper evident lobster trap 1000 operation;

FIG. 4A is a prospective view of a lobster trap; and,

FIG. 4B is a plan view of the lobster trap of FIG. 4A.

In the figures, the following reference numerals represent the associated components of the disclosed device and system:

Lobster trap or cage—1000;

Sensor—2000;

Battery—3000;

Housing Receptacle—4000;

Attachment Loops—4100;

Weight Detector—5000;

Mechanical Switch—6000; and

Lever Arm—7000.

It is to be noted, however, that the appended figures illustrate only typical embodiments of this invention and are therefore not to be considered limiting of its scope, for the invention may admit to other equally effective embodiments that will be appreciated by those reasonably skilled in the relevant arts. Also, figures are not necessarily made to scale but are representative.

### DETAILED DESCRIPTION OF PROFFERED EMBODIMENTS

Disclosed generally is a tamper evident lobster trap. In use, the invention may operate to detect and alert a user to theft of lobsters and tampering of the harvesting process. The more specific aspects of the disclosed device are described below with reference to the appended figures.

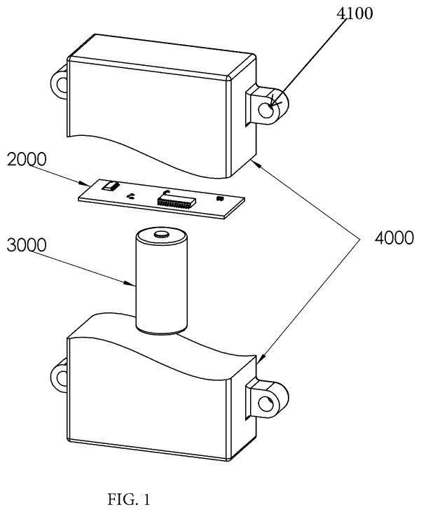

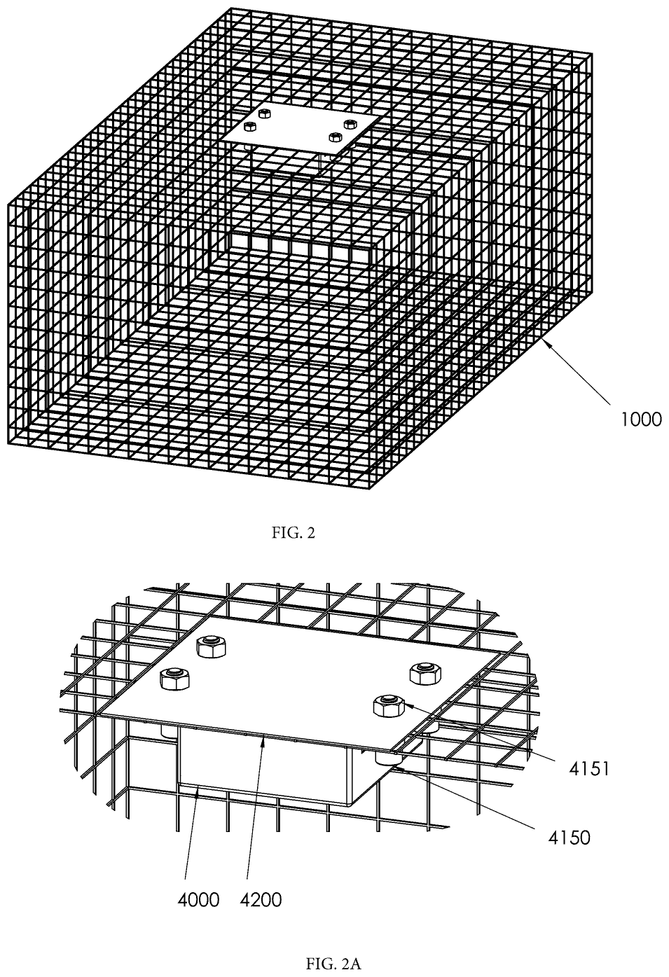

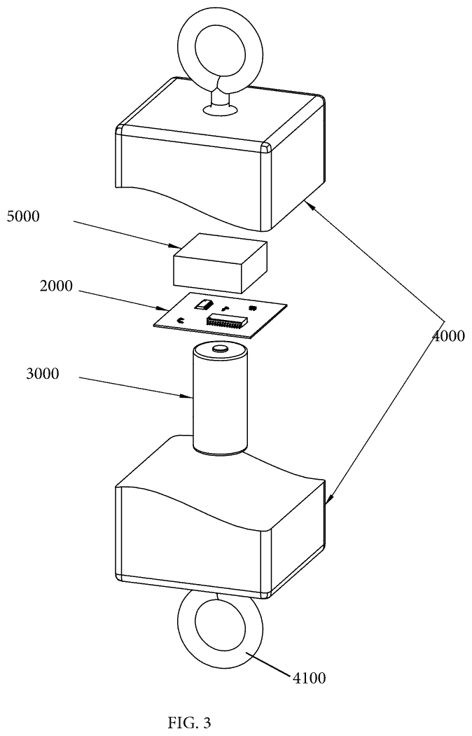

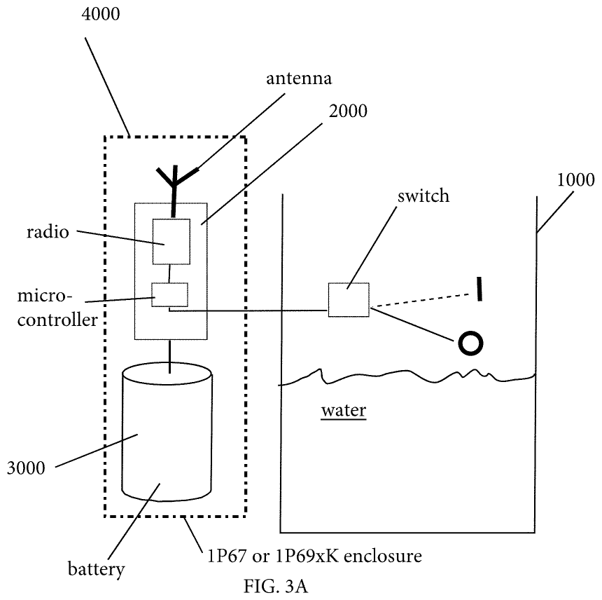

FIG. 1 is an exploded view of the housing receptacle 4000. Suitably, the figure shows or otherwise displays the contents therein, namely the sensor electronics and processor 2000 and battery 3000. FIG. 2 is an environmental view of the lobster trap 1000 with the housing receptacle 4000 attached to the top inner surface. FIG. 2A is a zoom-in view of the lobster trap 1000 of FIG. 2. FIG. 3 is an exploded view of the housing receptacle 4000 with attachment loops 4100 connected to the outer opposing surfaces of the receptacle. FIG. 3 also displays a weight detector 5000 housed along with the sensor 2000 and battery 3000 within the housing receptacle 4000.

FIGS. 1, and 3 show the sensor electronics and processor 2000 and the battery 3000. The sensor 2000 and battery 3000 are contained within the housing receptacle 4000. The sensor electronics and processor 2000 is situated on top of the battery 3000. The sensor detects changes in water pressure that accompany a change in depth. The deeper the sensor is, the more pressure it experiences due to the weight of the water above it. The pressure on the sensor below the surface of the water is calculated by the sensor and translated to a database using a formulaic approach that accounts for the density of sea water and the atmospheric pressure. Suitably, sensor electronics and processor 2000 features an antenna, a radio receiver and transmitter, and a microcontroller for communicating changes in pressure to the database stored. In one embodiment, the sensor electronics and processor 2000 may be defined by a 1P67 or 1P69xK waterproof and fanless industrial computer.

FIGS. 1-3 show the housing receptacle 4000. The housing receptacle 4000 encompasses the sensor 2000, the battery 3000, and, in one embodiment, a weight detector 5000 and attachment loops 4100. The housing receptacle 4000 is fixated to the inner top surface of the lobster cage via traditional nut and bolt attachment. Once attached to the inner surface of the trap, the housing receptacle 4000 is entirely enclose within the lobster trap.

FIG. 2. Shows the lobster trap 1000. FIG. 2A shows a zoom-in view of the trap 1000 of FIG. 2. The lobster trap can vary in size from 30″ L×18″ W×12″ H to 36″ L×21″ W×13.5″ H. Typical lobster traps can be constructed of wire and wood, or of a wire gauge construction with the majority of newer traps consisting of vinyl coated metal frames. The housing receptacle 4000 attaches to the inner surface of the lobster trap 1000 such that when the trap is resting on the ocean floor, the housing receptacle 4000 is fixated to the top inner surface of the trap 1000. Suitably, the housing receptacle 4000 may be attached via screws through the attachment loops 4100.

FIG. 3A is a schematic of the typical operation of the tamper evident lobster trap 1000. In a typical embodiment, the lobster trap features sensor electronics and processor 2000, which features an antenna, a radio receiver and transmitter, and a microcontroller for communicating changes in pressure or weight to a database. In one embodiment, the sensor electronics and processor 2000 may be defined by a 1P67 or 1P69xK waterproof and fanless industrial computer that is configured to communicate wirelessly via the radio transmitter and antenna to a database. The sensor comprises an electronic sensor and process powered by a battery and enclosed in a housing receptacle. In one embodiment, the sensor detects pressure changes and is activated via these changes. For instance, when the pressure sensor is taken out of the water, as shown in FIG. 3A, a pressurized switch may activate. Suitably, the pressure-detecting sensor remains dormant while below a certain depth of water and then activates once above water to record the altered status of the trap to the database. In a preferred embodiment, the date, time, and weight of the cage, etc. is recorded to the sensor's database whenever the trap is raised above the water surface allowing for the inference of tampering from data recorded on the sensor.

In another embodiment, a weight detector is attached to the lobster trap along with the sensor. Suitably, the weight detector monitors changes of weight of the lobster trap. In another embodiment, the data may be communicated via near-field communication techniques to either a boat, cell phone, or the like. In yet another embodiment attachment loops may be connected to the pressure-detecting sensor to facilitate extraction of the lobster trap from water.

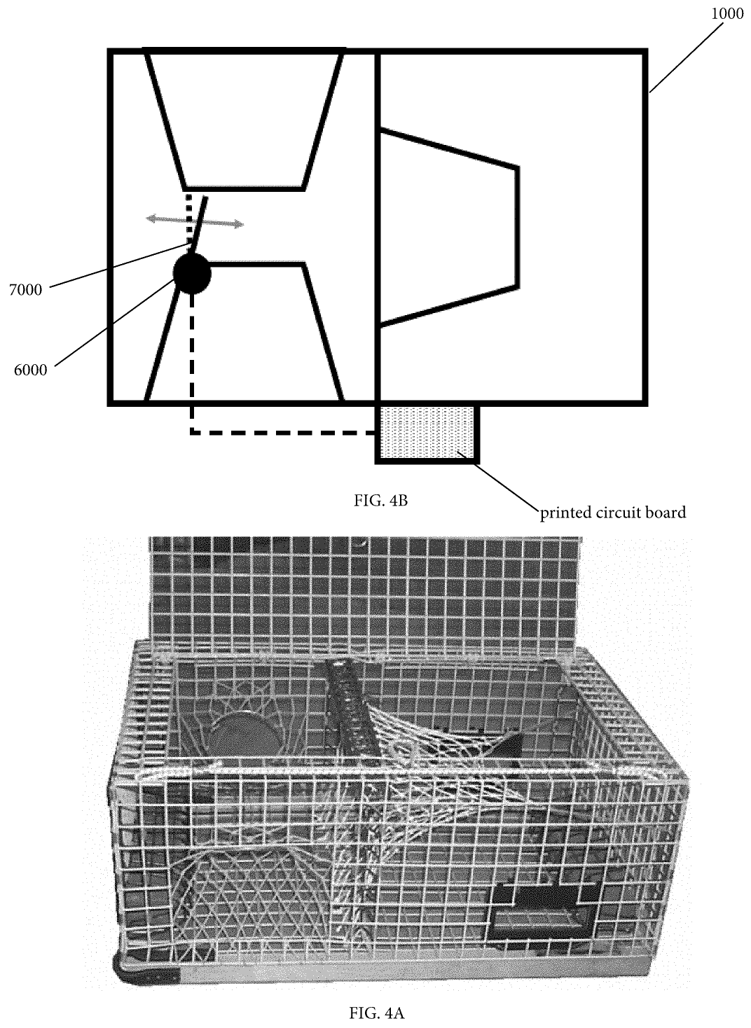

FIGS. 4A and 4B show the lever arm 7000 that is hingeably attached to the top of the lobster trap 1000 and to the mechanical switch 6000. The lever arm 7000 rests in a neutral hanging position between the entrances/exits of the lobster trap 1000. The lever arm 7000 is toggled, or pushed at its distal, unattached end as a lobster makes contact with the lever arm 7000 as it enters or exits the lobster trap 1000. When the lever arm is toggled by lobster movement, the lever arm 7000 activates the mechanical switch 6000, triggering a monitoring system to record the time and account for the number of lobsters entering/exiting the trap. The mechanical switch 6000 is wired to a Printed Circuit Board which records the information collected from the movement of the lever arm 7000 and attached mechanical switch 7000. The mechanical switch 6000 is defined by a spring loaded switch that may be at any time in one of three separate positions. The mechanical switch 6000 is in a resting or neutral position when the lever arm 7000 is hanging between the lobster trap 1000 entrances/exits undisturbed. The mechanical switch is in a forward activated position when the lever arm 7000 is pushed by a lobster entering the lobster trap 1000, thereby causing the lever arm 7000 to swing in a hinge-like fashion and trigger the mechanical switch 6000. The mechanical switch 6000 is in a backward activated position when the lever arm 7000 is pushed by a lobster exiting the lobster trap 1000, thereby causing the lever arm 7000 to swing in a hinge-like fashion and trigger the mechanical switch 6000. Once the lobster has entered or exited the lobster trap 1000, the spring causes the mechanical switch 6000 to return to its neutral or resting position.

Although the method and apparatus is described above in terms of various exemplary embodiments and implementations, it should be understood that the various features, aspects and functionality described in one or more of the individual embodiments are not limited in their applicability to the particular embodiment with which they are described, but instead might be applied, alone or in various combinations, to one or more of the other embodiments of the disclosed method and apparatus, whether or not such embodiments are described and whether or not such features are presented as being a part of a described embodiment. Thus the breadth and scope of the claimed invention should not be limited by any of the above-described embodiments.

Terms and phrases used in this document, and variations thereof, unless otherwise expressly stated, should be construed as open-ended as opposed to limiting. As examples of the foregoing: the term “including” should be read as meaning “including, without limitation” or the like, the term “example” is used to provide exemplary instances of the item in discussion, not an exhaustive or limiting list thereof, the terms “a” or “an” should be read as meaning “at least one,” “one or more,” or the like, and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that might be available or known now or at any time in the future. Likewise, where this document refers to technologies that would be apparent or known to one of ordinary skill in the art, such technologies encompass those apparent or known to the skilled artisan now or at any time in the future.

The presence of broadening words and phrases such as “one or more,” “at least,” “but not limited to” or other like phrases in some instances shall not be read to mean that the narrower case is intended or required in instances where such broadening phrases might be absent. The use of the term “assembly” does not imply that the components or functionality described or claimed as part of the module are all configured in a common package. Indeed, any or all of the various components of a module, whether control logic or other components, might be combined in a single package or separately maintained and might further be distributed across multiple locations.

Additionally, the various embodiments set forth herein are described in terms of exemplary block diagrams, flow charts and other illustrations. As will become apparent to one of ordinary skill in the art after reading this document, the illustrated embodiments and their various alternatives might be implemented without confinement to the illustrated examples. For example, block diagrams and their accompanying description should not be construed as mandating a particular architecture or configuration.

All original claims submitted with this specification are incorporated by reference in their entirety as if fully set forth herein.

1. A tamper evident lobster trap comprising:
a cage with an entrance;
a mounting plate on a top and outside of the cage;
a housing receptacle on a top and inside of the cage and coupled to the mounting plate so that the housing receptacle is secured to the cage;
a pressure sensor electrically coupled to a processor defined by a fanless computer, said pressure sensor and fanless computer positioned in the housing receptacle, where said pressure sensor is configured to activate a switch when the pressure sensor taken from a state that is submerged in water to a state that is not submerged in water, wherein fanless computer is further coupled to an antenna for sending a first radio signal when the switch is activated;
a battery that is positioned in the housing receptacle and electrically coupled to the pressure sensor, switch and the fanless computer; and
a spring-loaded lever arm coupled to the entrance so that the lever arm is toggled when a lobster enters or exits the cage through the entrance, wherein the lever arm is coupled to a mechanical switch, said mechanical switch coupled to a printed circuit board for recording a toggling event of the lever arm without triggering the first radio signal.

2. (canceled)

3. (canceled)

4. (canceled)

5. (canceled)

6. The tamper evident lobster trap of claim 1 further comprising a temperature sensor coupled to the fanless computer so that a second radio signal can be sent via said antenna when a change in temperature is sensed.

7. The tamper evident lobster rap of claim 6 further wherein the printed circuit board is coupled to the fanless computer and wherein the first or second radio signal includes the record of the printed circuit board.
